(19) United States
(12) Patent Application Publication
(10) Pub. No.: US 2010/0219652 A1
(43) Pub. Date: Sep. 2, 2010

(54) Slide-Out Mechanism With Adhesive Connections

(76) Inventors: Craig J. Reske, Niles, MI (US); Timothy D. Schultz, Mishawaka, IN (US)

Correspondence Address: QUARLES & BRADY LLP, 411 E. WISCONSIN AVENUE, SUITE 2040, MILWAUKEE, WI, 53202-4497, US

(21) Appl. No.: 12/713,852

(22) Filed: Feb. 26, 2010

Related U.S. Application Data
(60) Provisional application No. 61/156,303, filed on Feb. 27, 2009.

(51) Int. Cl. B60P 3/34

(52) U.S. Cl. 296/26.13

(57) ABSTRACT

A slide-out mechanism for moving a slide-out section of a vehicle relative to a second section of the vehicle is disclosed. The slide-out mechanism comprises a stationary frame configured to connect to the second section of the vehicle and a movable frame that movably connects to the stationary frame and is configured to connect to the slide-out section. The slide-out mechanism further comprises a drive assembly that is operable to move the movable frame, and a rack and pinion assembly that operatively connects the drive assembly and the movable frame. The rack of the rack and pinion assembly includes a back surface having an adhesive thereon to connect to an adjacent component.

### CROSS-REFERENCE TO RELATED APPLICATION

This application claims benefit to U.S. Provisional Patent Application No. 61/156,303, filed Feb. 27, 2009.

### STATEMENT CONCERNING FEDERALLY SPONSORED RESEARCH OR DEVELOPMENT

Not applicable.

### FIELD OF THE INVENTION

This invention relates to slide-out mechanisms for vehicles, and particularly relates to slide-out mechanisms that move a slide-out section of a vehicle relative to a second section of the vehicle.

### BACKGROUND OF THE INVENTION

In order to increase the available interior space of recreational vehicles (such as trailers or motorhomes), it is known to provide a slide-out section (such as a bedroom) as part of the structure of the vehicle. A slide-out section is a raised platform enclosed on all sides except one. Typically, the open side is positioned for access to the slide-out section from inside the vehicle. During transit, the slide-out section is retracted and stored in the interior of the vehicle, and the exterior wall of the slide-out section is generally flush with the exterior of the vehicle. The slide-out section is used after the vehicle is parked and leveled by moving the slide-out section outward from the vehicle to an extended position, thereby increasing the interior space of the vehicle.

The operating mechanism for moving slide-out sections are typically designed to push the slide-out section away from the vehicle when extending the slide-out section, and pull the slide-out section toward or into the vehicle when retracting the slide-out section. The slide-out mechanism for moving the slide-out section relative to the vehicle includes a frame that is fixed to the vehicle structure, and the slide-out mechanism can include one or more sliding rails attached to the slide-out section. Typically, these sliding rails move within rail supports of the frame. Multiple sliding rails are typically utilized for wide slide-out sections. The sliding rails may be driven by a single drive assembly. Thus, in mechanisms having two sliding rails, both rails are directly driven by a drive assembly, for example by one shaft with two pinion gears, one pinion gear for each rail. In other designs, the sliding rails are driven independently of each other. The motion of the slide-out mechanisms is preferably synchronized to prevent the slide-out section from binding or becoming skewed relative to the vehicle.

In addition, current slide-out mechanisms typically include certain components that support relatively high loads, such as the components of the drive train through which the drive assembly drives the sliding rail. As a result, the components of the drive train are typically formed from a relatively high strength material, such as steel. Other components of current slide-out mechanisms are not subjected to high loads, and as a result are typically formed from a relatively inexpensive material, such as aluminum. In some cases, the steel and aluminum components are adjacent components that are to be connected, but these components can be difficult and expensive to connect by processes such as welding. In addition, using fasteners to connect steel and aluminum components increases the complexity of the slide-out mechanism, and additional processing steps may be needed to add features to the components, such as drilling and tapping.

Considering the limitations of current slide-out mechanisms, it would be desirable to have a slide-out mechanism with components that are simply and inexpensively connected to one another.

### SUMMARY OF THE INVENTION

In one aspect, the present invention provides a slide-out mechanism for moving a slide-out section of a vehicle relative to a second section of the vehicle. The slide-out mechanism comprises a stationary frame configured to connect to the second section of the vehicle and a movable frame that movably connects to the stationary frame and is configured to connect to the slide-out section. The slide-out mechanism further comprises a drive assembly that is operable to move the movable frame, and a rack and pinion assembly that operatively connects the drive assembly and the movable frame. The rack of the rack and pinion assembly includes a back surface having an adhesive thereon to connect to an adjacent component.

In another aspect, the present invention provides a slide-out mechanism for moving a slide-out section of a vehicle relative to a second section of the vehicle. The slide-out mechanism comprises a stationary frame configured to connect to the second section of the vehicle and a movable frame that movably connects to the stationary frame and is configured to connect to the slide-out section. The slide-out mechanism further comprises a drive assembly operable to move the movable frame, and a drive train that operatively connects the drive assembly and the movable frame. The drive train includes a pinion that rotatably connects to the drive assembly, a rack that fixedly connects to the movable frame and is in engagement with the pinion, and an adhesive disposed between the movable frame and the rack to fixedly connect the rack to the movable frame.

The foregoing and other objects and advantages of the invention will appear in the detailed description that follows. In the description, reference is made to the accompanying drawings that illustrate a preferred embodiment of the invention.

### BRIEF DESCRIPTION OF THE DRAWINGS

The invention will hereafter be described with reference to the accompanying drawings, wherein like reference numerals denote like elements, and:

FIG. 1 is a perspective view of a vehicle including a slide-out mechanism of the present invention;

FIG. 2 is a perspective view of the slide-out mechanism connected to the vehicle in FIG. 1;

FIG. 3 is an exploded perspective view of the slide-out mechanism of FIG. 2;

FIG. 4 is an end view of the slide-out mechanism of FIG. 2 showing the connection between a rail and a gear rack;

FIG. 5 is a side view of the slide-out mechanism of FIG. 2 showing a drive assembly; and

FIG. 6 is a bottom view of the slide-out mechanism of FIG. 2 showing the engagement of the gear rack and a pinion.

### DETAILED DESCRIPTION OF THE PREFERRED EMBODIMENT

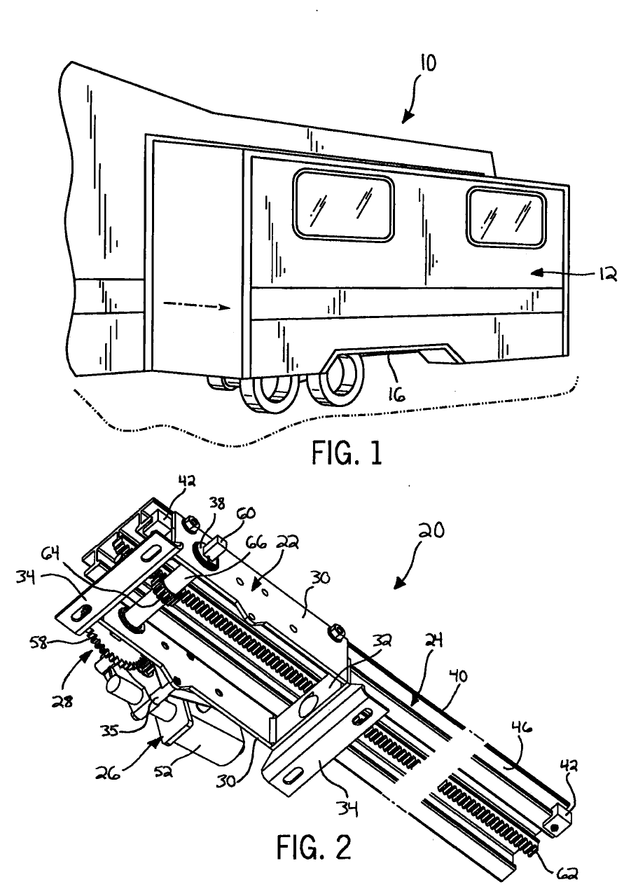

Referring to FIGS. 1 and 2, a slide-out mechanism 20 of the present invention is used with a vehicle 10 having a slide-out section 12. As described above, the slide-out section 12 increases the available interior space of the vehicle 10 by moving from a retracted position to an extended position. The slide-out mechanism 20 includes different components that connect to a lower surface 16 of the slide-out section 12 and a second section of the vehicle or a vehicle structure 14 (FIG. 5), such as a portion of the chassis, to move the slide-out section 12 between the extended and retracted positions. The vehicle 10 may include multiple slide-out mechanisms 20 depending on the size of the slide-out section 12 and/or the power output of the slide-out mechanisms 20.

Referring now to FIGS. 2-6, the slide-out mechanism 20 of the present invention moves the slide-out section 12 between the extended and retracted positions. The slide-out mechanism 20 generally includes a stationary frame 22 that fixedly connects to the vehicle structure, a movable frame 24 that fixedly connects to the slide-out section 12 and movably connects to the stationary frame 22, a drive assembly 26, and a drive train 28 that operatively connects the drive assembly 26 and the movable frame 24.

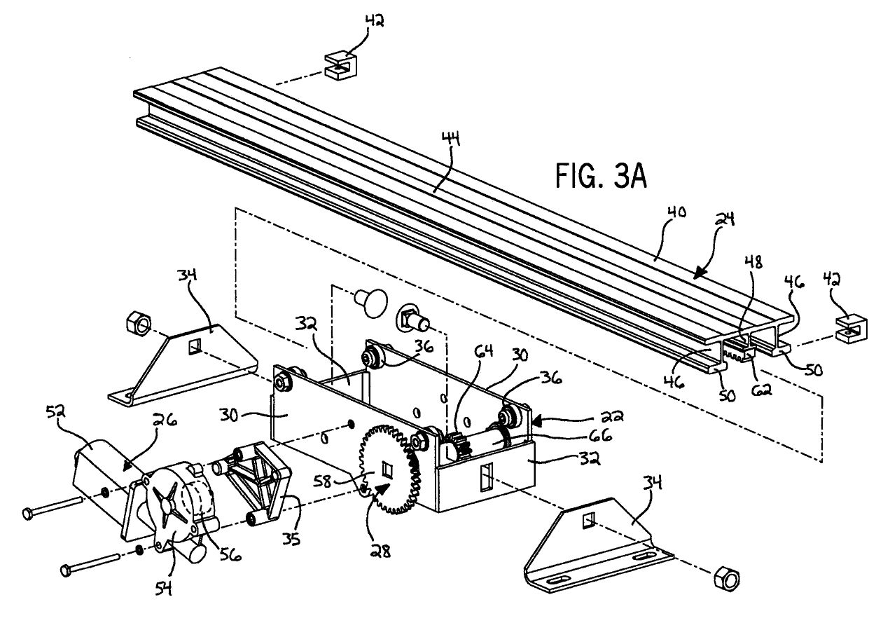

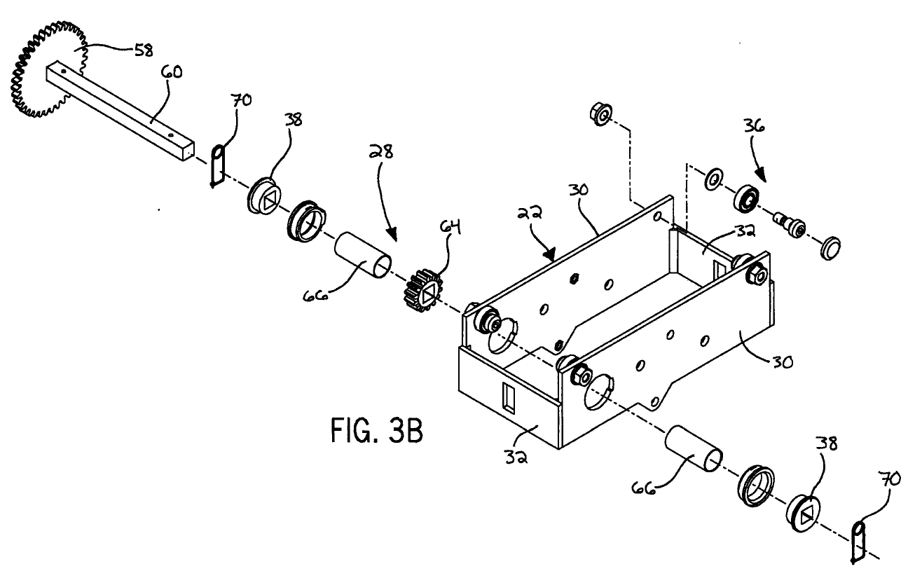

Referring to FIGS. 2 and 3, the stationary frame 22 includes several brackets in addition to guide rollers and bearings to connect to other components of the slide-out mechanism 20. The stationary frame 22 includes two side brackets 30, two end brackets 32 that connect the side brackets 30, two angled brackets 34 that connect the stationary frame 22 to the vehicle structure, and a spacer bracket 35 that fixedly connects one of the side brackets 30 to the drive assembly 26. The side brackets 30 and the end brackets 32 are generally flat components that may include holes to accommodate fasteners. Each angled bracket 34 includes two sections that are generally positioned at right angles from one another. Each angled bracket 34 also includes holes to accommodate fasteners that connect to either the end brackets 32 or the vehicle structure. Connecting the brackets 30, 32, and 34 to one another and the vehicle structure with fasteners may permit the brackets 30, 32, and 34 to be repositioned or easily replaced. Alternatively, the brackets 30, 32, and 34 may be connected to one another and the vehicle structure in other manners, such as welding and the like. The guide rollers 36 pivotally connect to the upper corners of the side brackets 30. The guide rollers 36 support and provide a movable connection to the movable frame 24. The bearings 38 pivotally connect to the side brackets 30 and provide a connection between the drive train 28 and the side brackets 30.

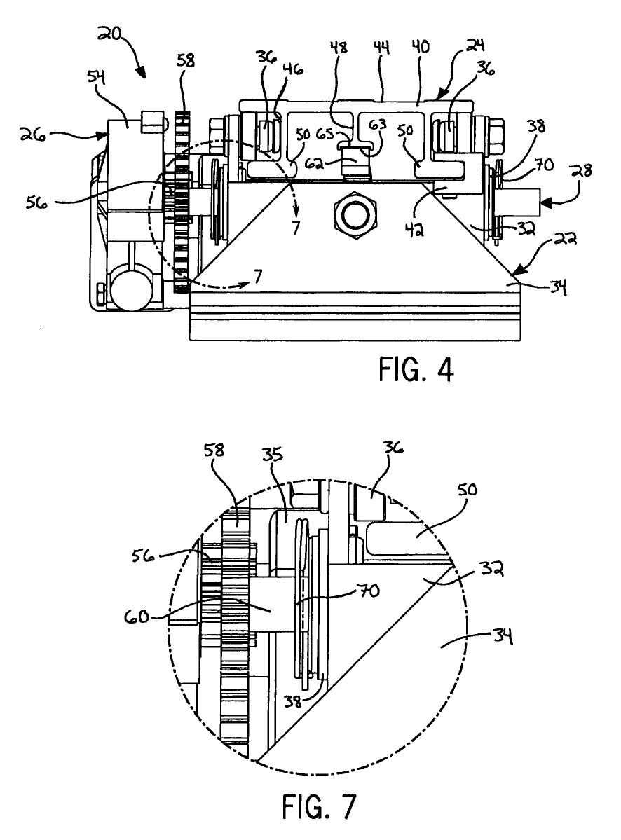

Still referring to FIGS. 2 and 3, the movable frame 24 includes a rail 40 and several stops 42 to limit the range of motion of the rail 40. The rail 40 is preferably made from a relatively inexpensive material, such as aluminum. As best shown in FIGS. 2 and 4, the sides of the rail 40 include channels 46 through which the guide rollers 36 pass as the movable frame 24 moves relative to the stationary frame 22. The rail 40 has a general triple I-beam shape that defines an upper section 44 that connects to the slide-out section 12 by fasteners or the like. In addition, a central section 48 of the rail 40 is generally T-shaped and connects to the drive train 28 as described below. The stops 42 limit the range of motion of the rail 40 by contacting the guide rollers 36. The stops 42 are preferably connected to foot sections 50 by set screws, thereby permitting the stops 42 to be repositioned. The stops 42 preferably connect to the foot sections 50 of the rail 40 near the ends of the channels 46 and, as a result, are preferably C-shaped. In addition, the stops 42 may be positioned along a single channel 46 or both channels 46 of the rail 40.

Referring now to FIGS. 3, 5, and 6, the drive assembly 26 preferably includes an electric motor 52 that drives a speed reducer 54. The electric motor 52 is preferably selected in conjunction with the speed reducer 54 and the drive train 28 such that sufficient torque is provided to move the movable frame 24 and the slide-out section 12. In addition, the electric motor 52 may be powered by the conventional battery of the vehicle or a separate battery that is dedicated to powering the slide-out mechanism 20. The speed reducer 54 operatively connects the electric motor 52 and the drive train 28 through a first gear 56. The speed reducer 54 may also include a worm (not shown) and a worm gear (not shown) that advantageously provide a relatively compact slide-out mechanism 20. However, other components may also be used, such as spur gears, helical gears, and the like.

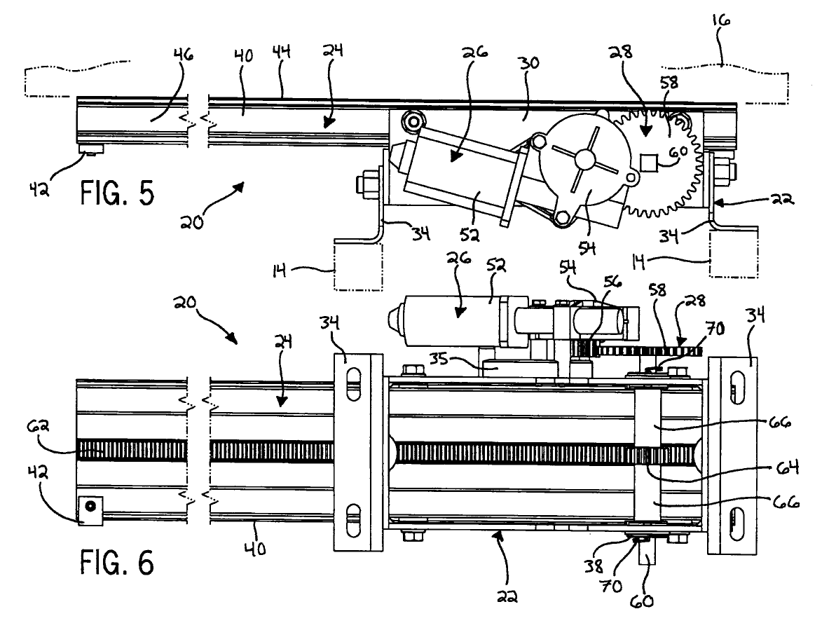

Referring now to FIGS. 3 and 6, the drive train 28 includes a second gear 58 that operatively connects the drive train 28 to the drive assembly 26, a rack and pinion assembly that connects to the movable frame 24, and a shaft 60 that operatively connects the second gear 58 to the rack and pinion assembly. The second gear 58 is positioned outside the stationary frame 22 along the shaft 60 and engages the first gear 56 to operatively connect the drive assembly 26 and the movable frame 24. The second gear 58 may be fixedly connected to the shaft 60 by welding or the like. In addition, the second gear 58 may have more teeth than the first gear 56 to provide an additional speed reduction and torque increase.

The rack 62 of the rack and pinion assembly is preferably made from a relatively strong material, such as steel. The rack 62 connects to a central channel 63 positioned on the bottom surface of the central section 48 of the rail 40. An adhesive is positioned between the central channel 63 and a back surface 65 of the rack 62 to connect the rack 62 to the rail 40. The adhesive may be an adhesive tape or an adhesive paste that is dispensed from a cartridge. The adhesive is preferably an acrylic adhesive, such as Lord 406 manufactured by Lord Corporation of Cary, N.C., USA. Other specific adhesives may be advantageous depending on the climate in which the slide-out mechanism 20 is used. For example, Lord 403 and Lord 410 may be advantageously used in cold and hot climates, respectively. The adhesive may be applied with an adhesive accelerator, such as Lord accelerator 19GB, to reduce the curing time of the adhesive. The adhesive preferably has a tensile strength greater than 32 MPa and a lap shear strength at room temperature greater than 17 MPa. In addition, the adhesive preferably has a glass transition temperature greater than 70° C.

The rack 62 and the central channel 63 preferably have a butt connection, which should be understood as meaning that the adhesive is positioned between the back surface 65 of the rack 62 and a lower surface of the central channel 63. The central channel 63 also preferably has side surfaces that simplify positioning of the rack 62 during assembly of the slide-out mechanism 20.

The pinion 64 of the rack and pinion assembly engages the rack 62 and may have fewer teeth than the second gear 58. The pinion 64 is preferably held in position on the shaft 60 by spacers 66. In addition, the shaft 60 rotatably connects to the side brackets 30 through the bearings 38 and preferably has a square cross section. Therefore, the second gear 58, the bearings 38, the spacers 66, and the pinion 64 preferably have square internal bores. Pins 70 positioned adjacent the bearings 38 outside the stationary frame 22 may connect to the shaft 60 to prevent the shaft 60 from moving axially.

The present invention advantageously provides a slide-out mechanism in which components made of dissimilar materials are simply and inexpensively connected to one another. However, the adhesive may also be used to connect components made of the same or similar materials. This may advantageously reduce the complexity of the assembly or the number of processing steps needed to assemble the slide-out mechanism.

A preferred embodiment of the invention has been described in considerable detail. Although some attention was given to various alternatives within the scope of the invention, it is anticipated that one skilled in the art will likely realize alternatives that are now apparent from disclosure of embodiments of the invention. Accordingly, the scope of the invention should be determined from the following claims and not limited by the above disclosure.

We claim:

1. A slide-out mechanism for moving a slide-out section of a vehicle relative to a second section of the vehicle, comprising:
a stationary frame configured to connect to the second section of the vehicle;
a movable frame configured to connect to the slide-out section and movably connected to the stationary frame;
a drive assembly operable to move the movable frame; and
a rack and pinion assembly that operatively connects the drive assembly and the movable frame, the rack of the rack and pinion assembly including a back surface having an adhesive thereon to connect to an adjacent component.

2. The slide-out mechanism of claim 1, wherein the movable frame includes an aluminum rail.

3. The slide-out mechanism of claim 1, wherein the rack is a steel component.

4. The slide-out mechanism of claim 1, wherein the adjacent component is a central channel of a rail of the movable frame.

5. The slide-out mechanism of claim 4, further comprising an adhesive accelerator disposed between the central channel of the rail and the back surface of the rack.

6. The slide-out mechanism of claim 5, wherein the adhesive accelerator is Lord 19GB.

7. The slide-out mechanism of claim 1, wherein the adhesive is an acrylic adhesive.

8. The slide-out mechanism of claim 7, wherein the adhesive is one of Lord 403, 406, and 410 acrylic adhesives.

9. The slide-out mechanism of claim 1, wherein the adhesive is an adhesive paste.

10. The slide-out mechanism of claim 1, wherein the adhesive is an adhesive tape.

11. A slide-out mechanism for moving a slide-out section of a vehicle relative to a second section of the vehicle, comprising:
a stationary frame configured to connect to the second section of the vehicle;
a movable frame configured to connect to the slide-out section and movably connected to the stationary frame;
a drive assembly operable to move the movable frame;
a drive train that operatively connects the drive assembly and the movable frame, including:
a pinion rotatably connected to the drive assembly;
a rack fixedly connected to the movable frame and in engagement with the pinion; and
an adhesive disposed between the movable frame and the rack to fixedly connect the rack to the movable frame.

12. The slide-out mechanism of claim 11, wherein the adhesive is an adhesive paste.

13. The slide-out mechanism of claim 11, wherein the movable frame includes an aluminum rail and the rack is a steel component.

14. The slide-out mechanism of claim 13, wherein the adhesive is an acrylic adhesive.

15. The slide-out mechanism of claim 14, wherein the adhesive is one of Lord 403, 406, and 410 acrylic adhesives.

16. The slide-out mechanism of claim 15, further comprising an adhesive accelerator disposed between the movable frame and the rack.

17. The slide-out mechanism of claim 16, wherein the adhesive accelerator is Lord 19GB.

18. The slide-out mechanism of claim 17, wherein the aluminum rail includes a central channel to which the adhesive is connected.
